(19) United States
(12) Patent Application Publication
(10) Pub. No.: US 2022/0082504 A1
(43) Pub. Date: Mar. 17, 2022

(54) SURFACE DILUTION FOR SENSOR CALIBRATION

(71) Applicant: Hewlett-Packard Development Company, L.P., Spring, TX (US)

(72) Inventors: Fausto D'Apuzzo, Palo Alto, CA (US); Steven Barcelo, Palo Alto, CA (US); Anita Rogacs, San Diego, CA (US)

(73) Assignee: Hewlett-Packard Development Company, L.P., Spring, TX (US)

(21) Appl. No.: 17/415,203

(22) PCT Filed: Jun. 4, 2019
(86) PCT No.: PCT/US2019/035347

§ 371 Date: Jun. 17, 2021

(51) Int. Cl. G01N 21/65; G01N 21/27

(52) U.S. Cl. CPC G01N 21/658; G01N 21/274

(57) ABSTRACT

Systems and methods for generating calibration curve for a sensor are provided. An example method includes printing at least two spots of an analyte on the sensor, wherein each of the spots includes a different number of overprinted droplets ejected from a single printhead.

### BACKGROUND

Plasmonic sensing is a powerful tool for trace level chemical detection. However, quantitation may be difficult due to variation in sensors. Various techniques have been tested to improve the quantification, such as incorporating an active compound into the structure of a plasmonic sensor, or incorporating enhanced testing of sensors.

### DESCRIPTION OF THE DRAWINGS

Certain exemplary embodiments are described in the following detailed description and in reference to the drawings, in which:

FIG. 1 is a schematic diagram of a process for the calibration of a plasmonic sensor that has been surface enhanced via the controlled dispensing of volumes of a target analyte by varying the number of droplets dispensed, in accordance with an example;

FIG. 2 is a schematic drawing of a system for measuring a calibration curve by using a number of overprinted droplets to vary dispensed volumes on a plasmonic sensor, in accordance with an example;

FIG. 3 is a schematic diagram of a process for obtaining a concentration estimate using a multiple droplet technique to adjust volume supplied to a plasmonic sensor, in accordance with an example;

FIG. 4 is a drawing of a spherical model for determining the area of a droplet on the surface, in accordance with an example;

FIG. 5 is a series of plots of molecular surface density versus dispensed volume generated using the relationships described herein, in accordance with examples;

FIGS. 6A and 6B are drawings of a plasmonic sensor with a series of spots having different molecular densities of a calibration solution are formed by being overprinted with different numbers of droplets, in accordance with examples;

FIGS. 7A and 7B are drawings of a plasmonic sensor with a series of spots having different molecular densities for both a calibration solution and an analyte solution, in accordance with examples;

FIG. 8A is a micrograph of a plasmonic sensor showing the spots of different concentrations, in accordance with an example;

FIG. 8B is a map of the micrograph, showing the locations of the spots, in accordance with an example;

FIG. 9 is a process flow diagram of a method for generating a calibration curve for sensor, in accordance with an example; and

FIG. 10 is a process flow diagram of a method for measuring the concentration of an analyte, in accordance with an example.

### DETAILED DESCRIPTION

Plasmonic sensors, including surface enhanced Raman spectroscopy (SERS) sensors, are powerful tools for trace level chemical detection, but often suffer from significant variation between measurements, making quantification difficult. Methods to address this include incorporating reference standards in the fabrication process or exposing multiple sensors to generate sufficient statistics, but these approaches can be complicated and expensive.

Techniques described herein allow for the incorporation of single-chip dilution, which will improve the alignment capabilities, allow better calibration for complex mixtures, and lead to a more automated measurement system. To perform sensor calibration, the molecular surface density of the target analyte may be varied. This can be achieved with a dispensing system that controls both the dispensed volume (V) and that predicts (or monitors) the surface area (A) covered by the dispensed volume. As a result, a standard dispense head and a single stock solution may be used, decreasing or eliminating manual dilution, and reducing cost, while providing a range of concentrations for generating a calibration curve. The method can be used to predict sensor performance of different affective molecular concentrations, and, thus, provide an in-situ calibration it can be used for quantitative measurements of chemicals.

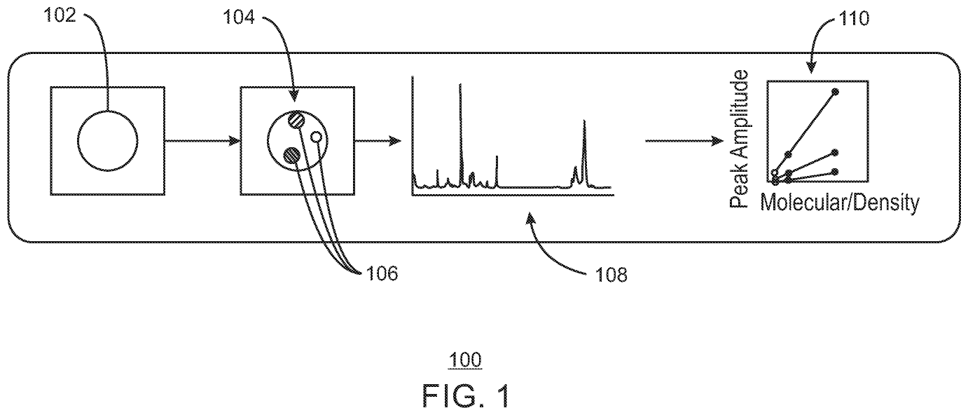

FIG. 1 is a schematic diagram of a process 100 for the calibration of a plasmonic sensor 102 that has been surface enhanced via the controlled dispensing of volumes 104 of a target analyte 106 by varying the number of droplets dispensed, in accordance with an example. In the present techniques, the molecular surface density of the dispensed volumes 104 is controlled by dispensing different amounts of an analyte solution through the overprinting of different numbers of droplets from a single microfluidic ejector, such as a nozzle of a thermal ink jet printhead. As used herein, overprinting is the dispensing of droplets onto a single target. In an example, the dispense footprint area (A) is predicted as a function of volume (V) via a contact angle model. In other examples, A is measured with the imaging system. The molecular surface density is estimated 108, and used for calibrating the sensor response curve 110. In examples, the process 100 is then repeated with an analyte of unknown concentration, using the previous results to yield a quantitative concentration measurement.

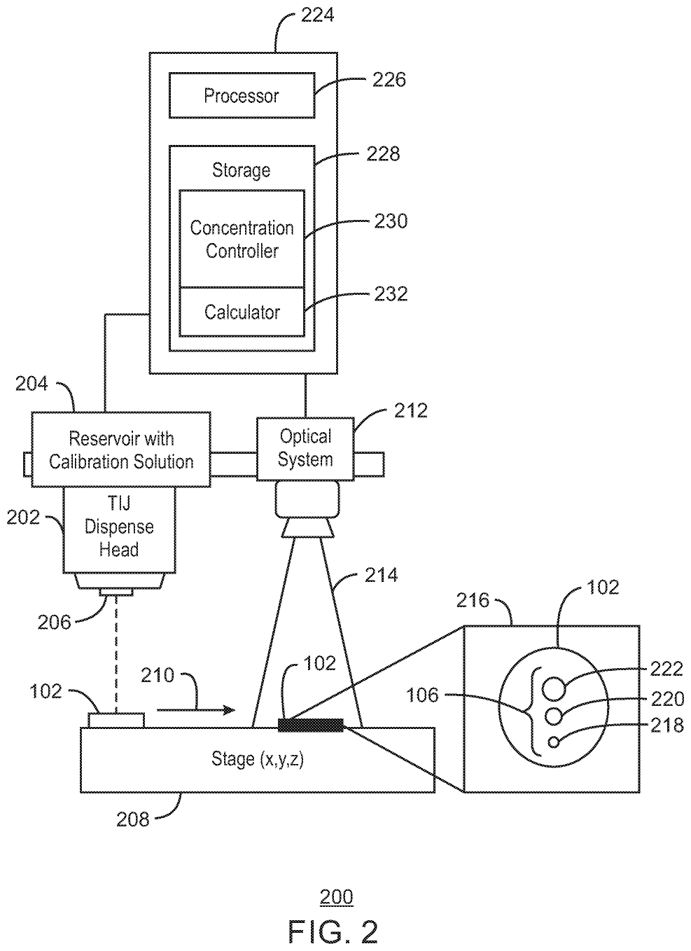

FIG. 2 is a schematic drawing of a system 200 for measuring a calibration curve by using a number of overprinted droplets to vary dispensed volumes 104 on a plasmonic sensor 102, in accordance with an example. In the system 200, a thermal ink jet (TIJ) dispense head 202 is fed with a calibration, or analyte, solution from a reservoir 204. A microfluidic ejector 206 on the TIJ dispense head 202 dispenses a controlled amount of volume by changing the number of droplets ejected from the microfluidic ejector at a particular location of the plasmonic sensor 102.

After the dispensed volumes 104 are ejected onto the plasmonic sensor 102, a translation stage 208 may be used to shift 210 the plasmonic sensor 102 under an optical system 212, which is used for measuring 214 a signal (P) from the plasmonic sensor 102. The optical system 212 may be a spectrophotometer, a hyperspectral camera, a line scanning spectrophotometer, or any number of other imaging systems that can be used to obtain spectral data, such as emission intensity over a wavelength range. In this example, three spots are formed, a first spot 218 is formed from a single ejected droplet of about 20 picoliters (pL), while a second spot 220 is formed from 10 ejected droplets, with a volume of about 200 pL. A third spot 222 is formed from 100 ejected droplets, with a volume of about 2000 pL. It may be noted that A is not linear with V in this example, but varies with drying time.

The system 200 includes a controller 224 that includes a processor 226 configured to control ejections of droplets from the microfluidic ejector 206. The controller 224 includes a data store 228, such as a programmable memory, a hard drive, a server drive, or the like.

The data store 228 includes modules to direct the operation of the system 200. The modules may include a concentration controller 230 that includes instructions that, when executed by the processor, direct the processor to print at least two different concentrations of the analyte on the plasmonic sensor 102. Each of the different concentrations is a spot on the sensor that includes a different number of overprinted droplets ejected from the microfluidic ejector 206. The modules may also include a concentration calculator 232 that includes instructions that, when executed by the processor, direct the processor to image 214 the plasmonic sensor 102, measure the signal from the plasmonic sensor 102, for example, caused by emission of light, and calculate the calibration curve based on the response.

The signal (P) from the plasmonic sensor 102 scales with the molecular surface density. This can be correlated with the volume (V), analyte concentration (C) and dispensed area (A). During calibration the transduction factors between these variables is fixed. During measurement, the concentration (C) is unknown, and it is estimated via measurement of P, V and A.

The relation between A and V depends on contact angle ϑ. In examples this is determined in advance and stored in a look-up table or model. This assumes that the wetting dynamics are reproducible, e.g., that the surface tension between the sensor in the solvent used is consistently reproducible.

In another example, in which the wetting of the plasmonic sensor 102 by the solvent used is not predictable, the optical system may include an imaging system, such as an imaging camera or a spectrophotometer used in line scan mode, to estimate the area, A, covered by the spots 218, 220, and 222 in the image 216. An imaging camera could also be used to define regions for later spectral analysis and to verify that adjacent spots are not overlapping.

The molecular surface density is estimated, from V, the concentration (C), and the area (A). The molecular surface density is not constant with volume, and thus can be modulated. Accordingly, the molecular surface density (OM) is related to the response from the sensor by the formula shown in equation 1.

P(λ_{S})∝δ_{M} EQN. 1

In equation one, λₛ represents the response from the sensor at a wavelength. Thus, δ_{M} for a particular volume, V, is calculated using the formula shown in equation 2.

$${δ}_{M} ( V ) = \frac{V C {N}_{A}}{A ( ϑ )} ∝ \frac{V}{{V}^{2 / 3}} ∝ {V}^{1 / 3} \qquad EQN . 2$$

In equation 2, V is the dispensed volume for the number of droplets ejected, C is the bulk concentration of the solution, N_{A} is Avogadro's number, and A is the footprint area of the dispensed volume at the contact angle, ϑ.

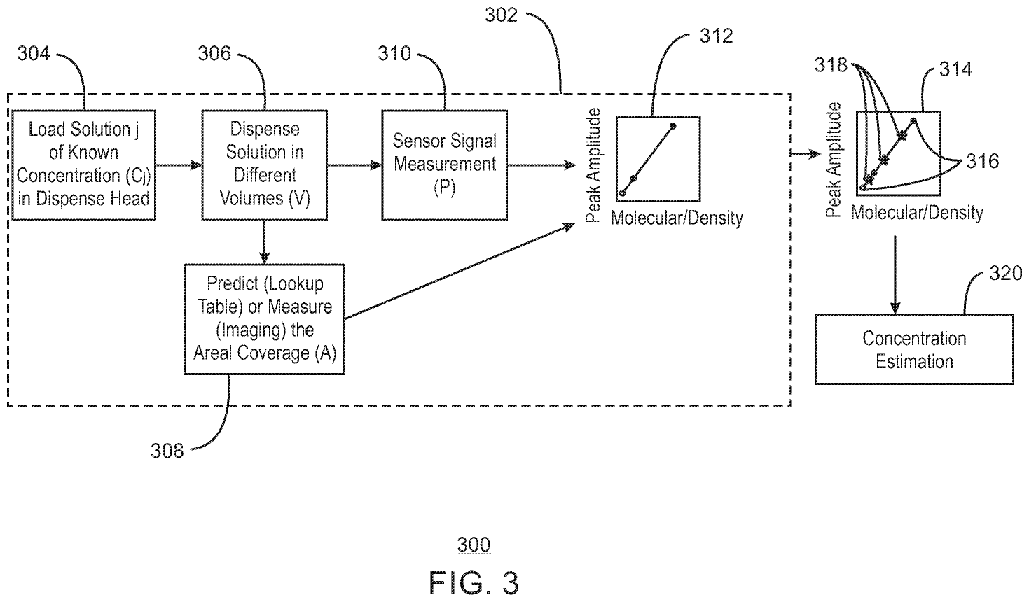

FIG. 3 is a schematic diagram of a process 300 for obtaining a concentration estimate using a multiple droplet technique to adjust volume supplied to a plasmonic sensor, in accordance with an example. The process 300 begins with a calibration procedure 302 used to estimate a calibration factor (D).

The calibration procedure starts at block 304 when a solution of known concentration (Cⱼ) is loaded into a reservoir coupled to a microfluidic ejector, for example, as shown for the reservoir 204 coupled to the TIJ dispense head 202 and the microfluidic ejector 206 in FIG. 2. In some examples, the reservoir is incorporated into the TIJ dispense head, lowering the need for fluidic coupling to external reservoirs. This may also decrease the amount of fluid needed, allowing for smaller sample sizes.

At block 306, the solution is dispensed in a number of different volumes (Vᵢ) to form spots on the sensor. As described herein, this is performed by ejecting a different number of droplets from a microfluidic ejector for each of the different volumes. At block 308, the area (Aᵢ) of each of the different spots is predicted from a lookup table, or measured by imaging, or both. If both are performed, then the measured value of the area for each of the different spots may be used to calibrate or validate the values in the lookup table. The area is then used to determine the molecular surface density of the analyte in each of the spots.

At block 310, the sensor signal (P) for each of the different spots may be measured. As described herein, this may be performed by a spectrophotometer, a hyperspectral camera, or other similar devices. In some examples, the sensor signal for a spot may be determined by integrating the emission across the area of the spot. In other examples, the sensor signal may be measured as the peak amplitude of the emission from a spot.

At block 312, the sensor signal and the molecular surface density are used to generate a calibration curve. This may be performed using equations 3 and 4.

P=D*δ_{M}(V, C₀) EQN. 3

In equation 3, D represents the calibration factor, C₀ represents the bulk concentration of the calibration solution, and the remaining terms are defined as for equations 1 and 2. Substituting in the terms of equation 3 with the terms from equations 1 and 2 provides equation 4, which can be used to estimate the calibration factor.

P=D*VC₀/A EQN. 4

The calibration procedure 302 is repeated at least once for the calibration solution and at least once for the analyte solution. Once the calibration factor, D, is determined the measurements from the calibration and analyte may be combined into a single curve 314 for estimating the concentration of the analyte. The single curve 314 includes data points 316 from running the calibration procedure 302 for the calibration solution, and data points 318 from running the calibration procedure 302 for the analyte solution.

At block 320, the concentration is estimated using the single curve 314. This is performed using equation 5 with the values obtained from the previous equations.

C₁=P*A/(D*V) EQN. 5

in equation 5, C₁ represents the calculated bulk concentration of the analyte solution. The other terms are as defined for the previous equations.

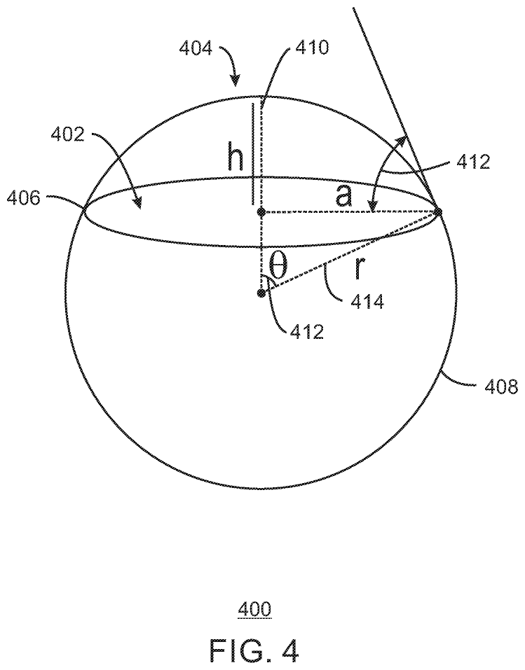

FIG. 4 is a drawing of a spherical model 400 for determining the area of a droplet on the surface, in accordance with an example. The spherical model 400 is a good simulation for droplet sizes below the fluid capillary length, e.g., which is 2.7 mm for water. The spherical model 400 is used to estimate the contact area 402 of a material 404 on a surface 406 based on an assumption that the contact area 402 is a portion of a virtual sphere 408. Thus, the material 404 on top of the surface is termed a spherical cap. The parameters used to calculate the contact area 402 includes the height 410 of the material 404 above the surface 406, the contact angle (θ) 412, and the radius (r) 414 of the virtual sphere 408. The volume of the spherical cap may be calculated as shown in equation 6.

$$V ( r , ϑ ) = \frac{π}{3} {r}^{3} ( 2 + cos ϑ ) {( 1 - cos ϑ )}^{2} \qquad EQN . 6$$

From this, the diameter of the spherical cap can be calculated as shown in equation 7.

$$d ( V , ϑ ) = 2 \times 1 {0}^{8} sin {ϑ}^{3} \sqrt{\frac{3 V}{π ( 2 + cos ϑ ) {( 1 - cos ϑ )}^{2}}} \qquad EQN . 7$$

Using the diameter calculated for the spherical cap, the molecular surface density can be calculated using the formula shown in equation 8.

$${δ}_{M} ( V , ϑ ) = \frac{V C {N}_{A}}{2 {π ( 1 {0}^{8} sin {ϑ}^{3} \sqrt{\frac{3 V}{π ( 2 + cos ϑ ) {( 1 - cos ϑ )}^{2}}} )}^{2}} ∝ {V}^{1 / 3} \qquad EQN . 8$$

In equation 8, the terms are as defined with respect to equation 2. The molecular surface density is in units of the number of molecules per square nanometer.

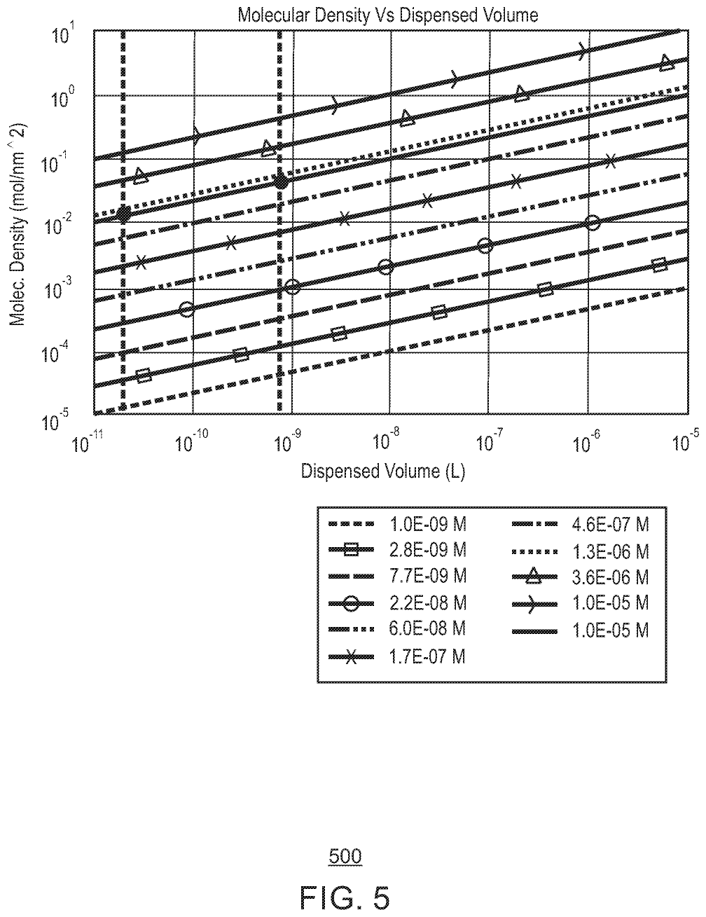

FIG. 5 is a series of plots 500 of molecular surface density versus dispensed volume generated using the relationships described herein, in accordance with examples. These plots may be used to generate a calibration curve as described herein.

### EXAMPLES

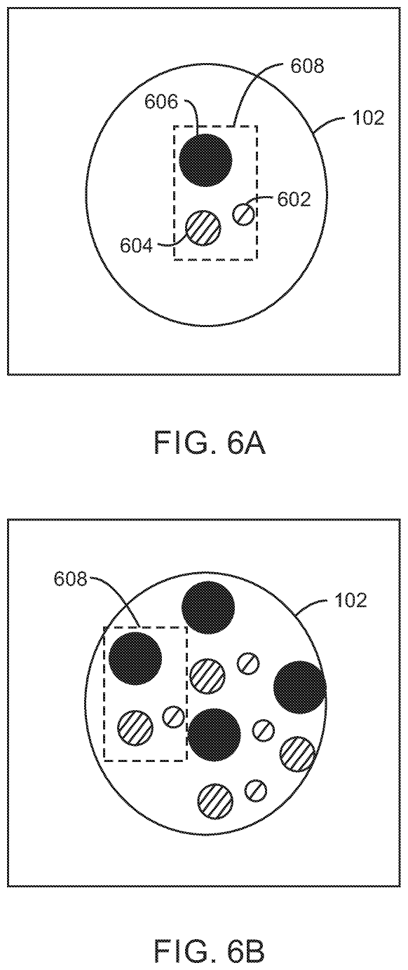

FIGS. 6A and 6B are drawings of a plasmonic sensor 102 with a series of spots having different molecular densities of a calibration solution are formed by being overprinted with different numbers of droplets, in accordance with examples. In FIG. 6A, three spots 602, 604, and 606 are shown. These may correspond to a single droplet for spot 602, ten droplets for spot 604 and one hundred droplets for spot 606, although any number of droplets may be used for each of the three concentrations. In this example, the three concentrations may correspond to a calibration group 608. As shown in FIG. 6B, multiple replicas of the calibration group 608 may be printed on a plasmonic sensor 102, depending on the surface area of the plasmonic sensor 102 and the areas of the spots.

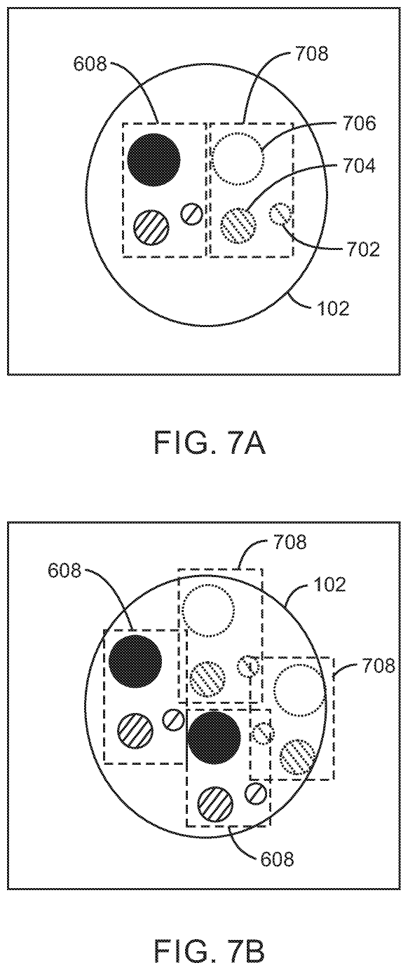

FIGS. 7A and 7B are drawings of a plasmonic sensor 102 with a series of spots having different molecular densities for both a calibration solution and an analyte solution, in accordance with examples. In FIG. 7A, the calibration group 608 of the calibration solution of FIG. 6A is printed on the plasmonic sensor 102 along with three spots 702, 704 and 706 of an analyte solution of different molecular densities. The different spots of the analyte solution correspond to an analyte group 708. As shown in FIG. 7B, multiple sets of the calibration group 608 and analyte group 708 may be printed on the surface of the plasmonic sensor 102.

The measured intensities of the spots 602, 604, 606, 702, 704, and 706 on the plasmonic sensor 102 may be used to determine the molecular densities in comparison to the dispensed volumes, for example, using the plots of FIG. 5. This allows the generation of a calibration factor in the determination of an estimate of the bulk concentration of the analyte solution.

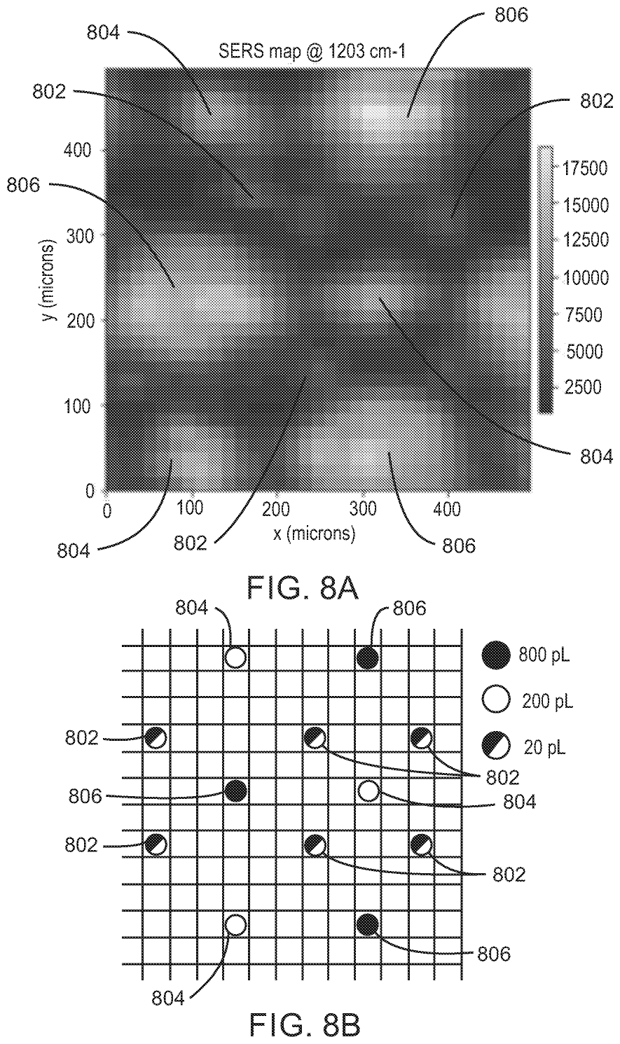

FIG. 8A is a micrograph of a plasmonic sensor showing the spots 802, 804, and 806 of different concentrations, in accordance with an example. Spots of larger intensity in the micrograph correspond to higher volumes, and, thus, higher molecular densities. In this example, the least intense spots 802 correspond to volumes of about 20 pL, while the middle intensity spots 804 correspond to volumes of about 200 pL, and the most intense spots 806 correspond to volumes of about 800 pL.

FIG. 8B is a map of the micrograph, showing the locations of the spots 802, 804, and 806, in accordance with an example. As can be seen by this map, and the micrograph, the space on the plasmonic sensor limits the use of the different volumes, as increasing the number of spots may lead to overlaps.

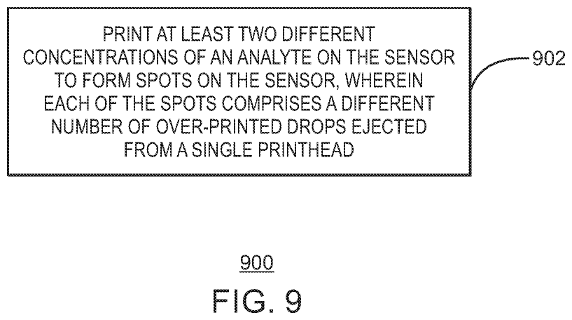

FIG. 9 is a process flow diagram of a method 900 for generating a calibration curve for sensor, in accordance with an example. At block 902, the method begins when at least two different concentrations of an analyte are printed on the sensor to form spots. Each of the spots comprises a different number of overprinted droplets ejected from a single printhead. As a result, each of the spots has a different volume applied, and thus a different molecular surface density of the material, for example, a first spot may be formed from 100 droplets and a second spot may be formed from 10 droplets. In an example, each droplet includes about 20 pL of an analyte solution.

The sensor includes a plasmonic detector. In one example, as described herein, the plasmonic detector is a surface enhanced Raman spectroscopy (SERS) sensor. Accordingly, the imaging system includes a detector capable of measuring Raman spectroscopic signals, such as a Raman spectrophotometer, or a hyperspectral camera. In examples, the imaging system is capable of measuring the area of spots on the sensor.

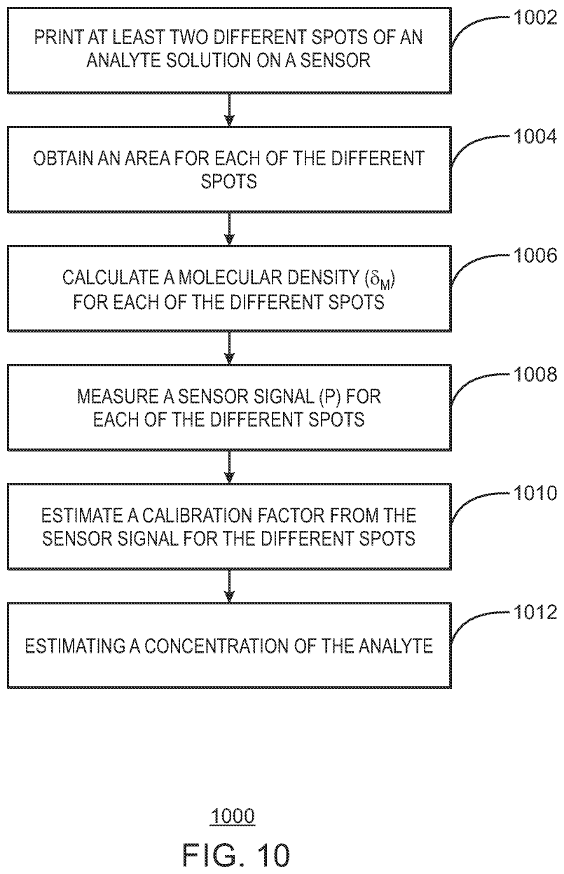

FIG. 10 is a process flow diagram of a method 1000 for measuring the concentration of an analyte, in accordance with an example. The method begins at block 1002, when at least 2 different concentrations of an analyte are printed on the sensor to form spots. Each of the spots comprises a different number of overprinted droplets ejected from a single microfluidic ejector.

At block 1004, and areas obtained for each of the different spots. In some examples, this is performed using a model, for example, as described with respect to

FIG. 4. In some examples, this is performed using an imaging system to directly measure the size of the spots.

At block 1006, a molecular surface density (δ) is calculated for each of the different spots. The molecular surface density may be calculated based, at least in part, on the bulk concentration (C) of the analyte and the area of each of the different spots. As described herein the molecular surface density may be calculated by the formula shown in equation 9.

$${δ}_{M} ( V , ϑ ) = \frac{V C {N}_{A}}{A ( V , ϑ )} \qquad EQN . 9$$

In equation 9, V is the dispensed volume, C is the bulk concentration, N_{A} is Avogadro's number, A is the area of the dispensed volume, and ϑ is the contact angle of the analyte solution with the sensor surface. The time between droplets may be increased until A(V,θ) becomes a constant, indicating that each droplet has time to completely dry before the next droplet is applied.

At block 1008, a sensor signal (P) is measured for each of the different spots on the sensor. In some examples, the sensor signal is the peak emission for each spot. In other examples, the sensor signal is the integrated emission over the area of the spot.

At block 1010, a calibration factor is estimated from the sensor signal for each of the different spots. As described herein, the calibration factor may be calculated by the formula shown in equation 10.

P=D*δ_{M}(V, C₀) EQN. 10

In equation 10, V is the dispensed volume, C₀ is the bulk concentration of the calibration solution, P is the sensor signal, and δ_{M} is the molecular surface density.

At block 1012, a concentration of the analyte is determined, for example, from the calibration factor. As described herein, the concentration of the analyte may be calculated by the formula shown in equation 11.

C₂=P*A/(D*V) EQN. 11

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the scope of the present techniques.

What is claimed is:

1. A method for generating a calibration curve for a sensor, comprising printing at least two spots of an analyte on the sensor to form spots on the sensor, wherein each of the spots comprises a different number of overprinted droplets ejected from a single printhead.

2. The method of claim 1, wherein increasing a number of overprinted droplets increases a molecular surface density of the analyte.

3. The method of claim 1, comprising printing a first spot comprising a first number of droplets and printing a second spot comprising a second number of droplets, wherein the first number of droplets is greater than the second number of droplets.

4. The method of claim 1, wherein each droplet comprises between about 10 picoliters and about 20 picoliters of an analyte solution.

5. The method of claim 1, comprising measuring an area of a spot on a sensor using an imaging system.

6. The method of claim 1, wherein the sensor comprises a plasmonic detector.

7. The method of claim 6, wherein the plasmonic detector comprises a surface enhanced Raman spectroscopy sensor.

8. A system for measuring a concentration of an analyte, comprising:
a printhead to print least two different spots of an analyte solution on a sensor, wherein each of the different spots comprises a different number of overprinted droplets of the analyte solution ejected from a single microfluidic ejector;
a measurement system to determine an area for each of the different spots;
a controller to calculate a molecular surface density (δ) for each of the different spots based, at least in part, on a bulk concentration (C) of the analyte and the area of each of the different spots;
an imaging system to measure a sensor signal (P) for each of the different spots on the sensor;
the controller to estimate a calibration factor (D) from the sensor signal for the different spots; and
the controller to estimate a concentration of the analyte based, at least in part, on the calibration factor.

9. The system of claim 8, wherein the controller calculates the molecular surface density (δ_{M}(V, [symbol] )) by a formula comprising:
$${δ}_{M} ( V , ϑ ) = \frac{V C {N}_{A}}{A ( V , ϑ )} ,$$
wherein V is a dispensed volume, C is a concentration, N_{A} is Avogadro's number, A is an area of the dispensed volume, and ϑ is a contact angle of the analyte solution with a sensor surface.

10. The system of claim 9, wherein the controller calculates the molecular surface density for each of the different spots based, at least in part, on a measurement of an area for a spot made by an imaging system.

11. The system of claim 8, wherein controller calculates the calibration factor (D) by a formula comprising:
P=D*δ_{M} (V, C₀),
wherein V is a dispensed volume, C₀ is a bulk concentration of a calibration solution, P is the sensor signal, and δ_{M} is the molecular surface density.

12. The system of claim 8, wherein controller calculates the concentration of the analyte (C₁) by a formula comprising:
C1=P*A/(D*V),
wherein V is a dispensed volume, D is the calibration factor, P is the sensor signal, A is an area of the dispensed volume, and V is the dispensed volume.

13. A system for generating a calibration curve for sensor, comprising:
a microfluidic ejector;
a reservoir comprising a solution of an analyte, wherein the reservoir is coupled to the microfluidic ejector;
a processor that is configured to control ejections of droplets from the microfluidic ejector; and
a data store comprising instructions that, when executed, direct the processor to print at least two different spots on the sensor, wherein each of the spots comprises a different number of overprinted droplets ejected from the microfluidic ejector.

14. The system of claim 13, wherein the sensor comprises a plasmonic sensor.

15. The system of claim 13, wherein the plasmonic sensor comprises a surface enhanced Raman spectroscopy (SERS) sensor.
